(19) United States
(12) Patent Application Publication
(10) Pub. No.: US 2016/0124975 A1
(43) Pub. Date: May 5, 2016

(54) LOCATION-AWARE DATA ACCESS

(71) Applicant: Microsoft Corporation, Redmond, WA (US)

(72) Inventors: Yi Zhang, Bothell, WA (US); Daniel Y Parish, Seattle, WA (US); Steven Charles Tullis, Redmond, WA (US); Fei Wu, Issaquah, WA (US)

(21) Appl. No.: 14/530,526

(22) Filed: Oct. 31, 2014

(51) Int. Cl. G06F 17/30

(52) U.S. Cl. CPC G06F 17/3087; G06F 17/30528

(57) ABSTRACT

Technologies are described herein for providing location-aware data access. In some configurations, techniques disclosed herein cause the display of selected categories of stored data depending on a geographic location of a computing device. Some illustrative configurations involve receiving a request to access data from a computing device. One or more devices may provide data defining a location of the computing device and a subset of the data may be selected based on the location of the computing device. The selected data may be displayed on a user interface or otherwise communicated to a computing device.

### BACKGROUND

In recent years, it has become more common for people to access centrally stored files from multiple locations. For example, a person may use remote storage services to store and access files from home, work or school. Although these services enable users to access data from multiple locations, most services do not provide tools that help users separate different categories of data. For example, a user may create folders to separate work-related files from school-related files. When using this practice, the user is required to manage new and existing files, and then navigate to a specific folder each time they access their data.

In other scenarios, tasks related to the management of data may require users to create a separation of data within a file or a program. Consider a scenario involving information gathering and multi-user collaboration programs that store notes, documents and other user information in a remote location. In such programs, a user may be required to organize and manage different sections of a document to separate content that relates to work, school and other subjects. Such tasks may require users to manage and maintain different data sets that may include tabs of a spreadsheet application, sections of a word processing document or sections of a note file. In addition, each time the user accesses the document, the user may need to navigate through different sections or pages to find content relevant to their current tasks.

It is with respect to these and other considerations that the disclosure made herein is presented.

### SUMMARY

Technologies are described herein for providing location-aware data access. In some configurations, techniques disclosed herein cause the display of selected categories of stored data depending on a geographic location of a computing device. Some illustrative configurations involve receiving a request to access data from a computing device. One or more devices may provide a location of the computing device requesting access to the data and a subset of the data may be selected based on the location of the computing device. Techniques presented herein might also generate a data structure configured to emphasize the selected subset of data. For instance, the selected data may be displayed on a user interface or otherwise communicated to a computing device. In some configurations, the techniques described herein may associate a priority with the selected data, and arrange a display of the selected data based on the priority and/or bring highlight to the selected data based on the priority.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing several example components of a system for providing location-aware data access.

FIG. 2 is a flow diagram illustrating aspects of a method for providing location-aware data access.

FIG. 3 illustrates a user interface displaying elements of a directory tree that are emphasized when stored data is accessed from a first location.

FIG. 4 illustrates a user interface displaying other elements of the directory tree that are emphasized when stored data is accessed from a second location.

FIG. 5 illustrates a user interface displaying elements of a note file that are emphasized when the note file is accessed from the first location.

FIG. 6 illustrates a user interface displaying other elements of the note file that are emphasized when the note file is accessed from the second location.

FIG. 7 illustrates a user interface displaying other elements of the note file that are emphasized when the note file is accessed from a third location.

FIG. 8 is a computer architecture diagram illustrating an illustrative computer hardware and software architecture for a computing system capable of implementing aspects of the techniques and technologies presented herein.

FIG. 9 is a diagram illustrating a distributed computing environment capable of implementing aspects of the techniques and technologies presented herein.

FIG. 10 is a computer architecture diagram illustrating a computing device architecture for a computing device capable of implementing aspects of the techniques and technologies presented herein.

### DETAILED DESCRIPTION

The following detailed description is directed to concepts and technologies for providing location-aware data access. In some configurations, techniques disclosed herein bring emphasis to selected data depending on a geographic location of a computing device. For example, a server computer may store a number of files. A subset of the files may be designated as work-related files, and another subset of the files may be designated as other categories, e.g., school-related files, personal files, etc. When a user accesses the files from a computing device located at an office, for example, techniques described herein may filter the files based on the location of the computing device and select the work-related files. The selected files may then be displayed on a user interface. Similarly, if the user accesses the files from a computing device at another location, for example, from a home, the personal files may be selected and displayed to the user.

In another illustrative example, a document may contain a number of sections, where some sections may be designated as work-related sections, and other sections may be related to other designated categories, e.g., school, personal, etc. If the user accesses the document from a computing device located at an office, for example, techniques described herein may select the work-related sections and generate a display of the data contained in the selected sections. Similarly, if the user accesses the files from a computing device at another location (e.g., a home), another category of sections, such as one or more sections containing personal data, may be selected and displayed to the user.

As will be described in more detail below, some illustrative configurations may involve receiving a request to access data from a computing device. One or more devices may provide a location of the computing device, and a subset of the data may be selected based on the location of the computing device. The selected subset of data may be displayed on a user interface or otherwise communicated to a computing device. In some configurations, the user interface may be configured to bring emphasis to the selected data. The techniques described herein may also associate a priority with the selected data. The user interface may be configured to bring emphasis to the selected data by arranging the selected data based on the priority and/or by bringing highlight to the selected data based on the priority.

The stored data may include any type of data having any structure, such as sections of a file, files or objects in a directory tree. In some configurations, a subset of the stored data may include part, object or element of the stored data, such as section of a file, a folder and/or subfolders. Techniques described herein may associate a subset of the stored data with a location, such as the user's home. When a computer is used to access the stored data from the location, the system may select the subset of the stored data based on the location of the computer. A display may be generated to highlight or focus on the selected subset of stored data. Highlight may be given to any part, object or element of the stored data, such as section of a file, a folder and/or subfolders.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

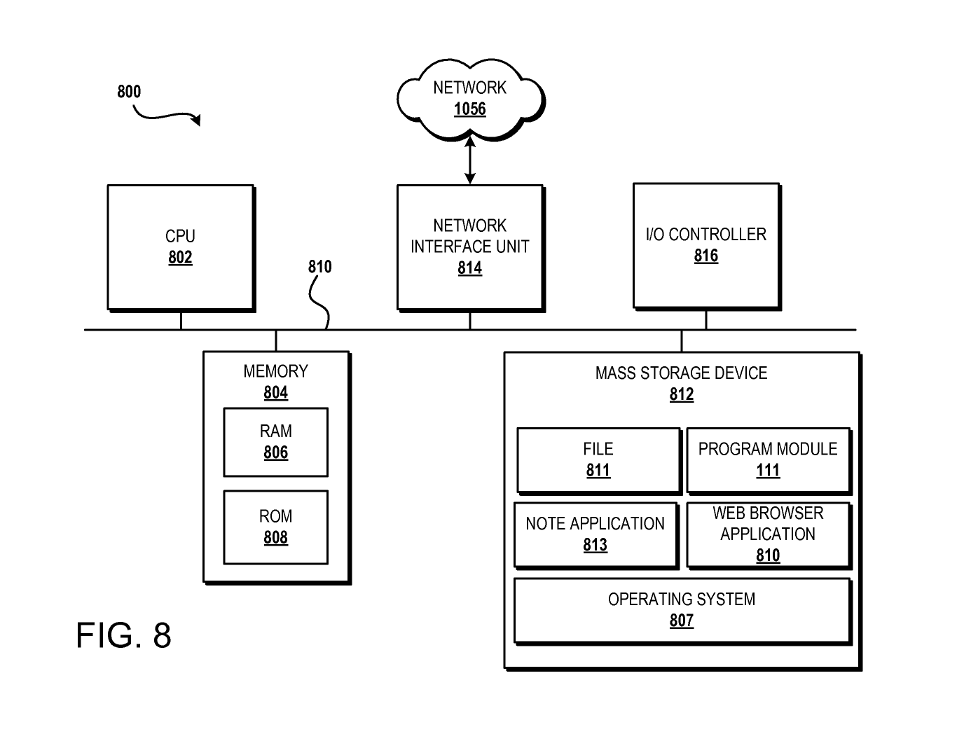

In the following detailed description, references are made to the accompanying drawings that form a part hereof, and in which are shown by way of illustration specific configurations or examples. Referring now to the drawings, in which like numerals represent like elements throughout the several figures, aspects of a computing system, computer-readable storage medium, and computer-implemented methodologies for providing location-aware data access. As will be described in more detail below with respect to FIGS. 8-10, there are a number of applications and services that can embody the functionality and techniques described herein.

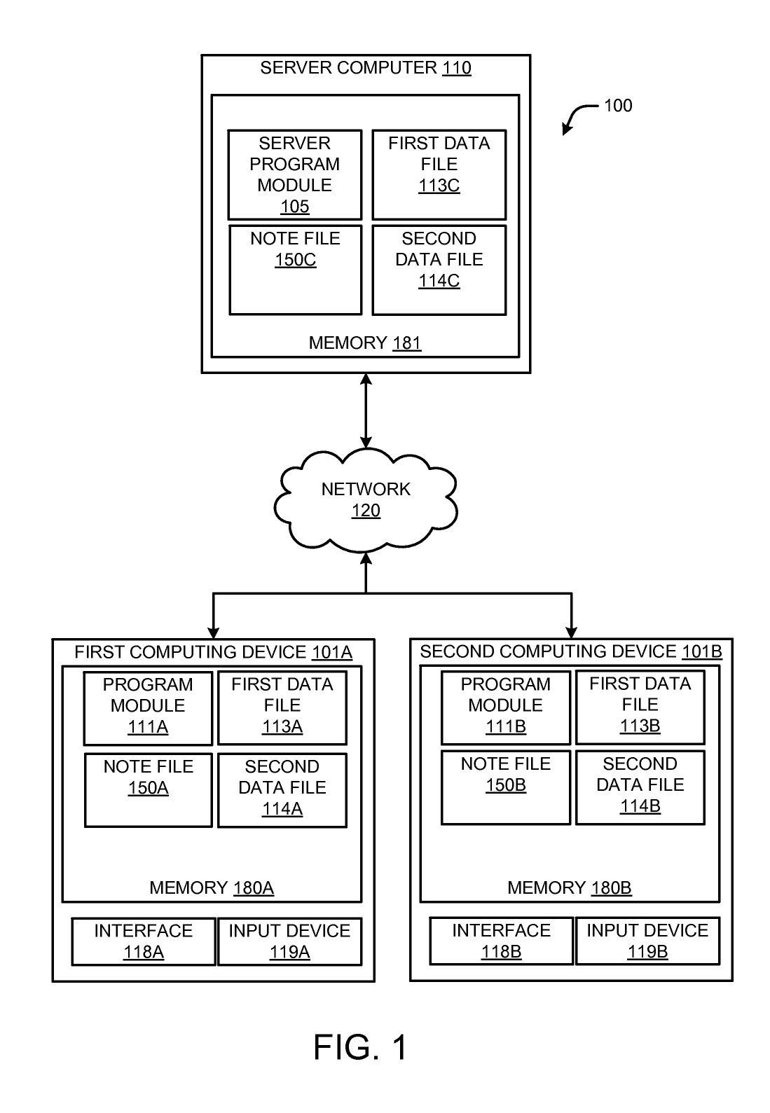

FIG. 1 is a system diagram showing aspects of one illustrative mechanism disclosed herein for providing location-aware data access. As shown in FIG. 1, a system 100 may include a first computing device 101A, a second computing device 101B, a server computer 110 and a network 120. The first computing device 101A and the second computing device 101B (also referred to collectively and/or generically as a “computing device 101”) may operate as stand-alone devices, or the computing devices 101 may operate in conjunction with the server computer 110 to perform the techniques disclosed herein. For illustrative purposes, two computing devices 101 are shown in FIG. 1 and it can be appreciated that fewer or more computing devices 101 may be used in implementations of the described techniques.

It can also be appreciated that the server computer 110 may be a personal computing device, a server or a number of computing devices configured to perform the techniques described herein. It can be also appreciated that the server computer 110 and the computing devices 101 are interconnected through one or more local and/or wide area networks, such as the network 120. It should be appreciated that many more network connections may be utilized than illustrated in FIG. 1.

The first computing device 101A may include memory 180A storing a first data file 113A, a second data file 114A, a note file 150A and a program module 111A. The second computing device 101B may also include memory 180B storing a first data file 113B, a second data file 114B, a note file 150B and a program module 111B in the memory 180B. In addition, the server computer 110 may also include memory 181 storing a first data file 113C, a second data file 114C, a note file 150B and a server program module 105.

For illustrative purposes, individual copies of the first data file 113A, 113B and 113C may be referred to herein generically and collectively as the “first data file 113.” As can be appreciated, the first data file 113 may be managed such that each copy stored on each device functions as a mirrored copy. It can also be appreciated that techniques for managing the first data file 113 may be similar to the functionality of a storage service, such as the GOOGLE DRIVE storage service from GOOGLE, Inc., the DROPBOX storage service from DROPBOX or the ONEDRIVE storage service from MICROSOFT CORPORATION. It can also be appreciated that the copies of the second data file (114A, 114B and 114C) may be managed in a manner that is similar to the first data file 113. For illustrative purposes, individual copies of the second data file are referenced as 114A, 114B and 114C and generically and collectively referred to herein as the “second data file 114.”

The first data file 113 and the second data file 114 may be organized in folders or the files may be located in a single folder or in separate folders. Regardless of the configuration or organization of the files, as will be described in more detail below, the techniques described herein may select and display files that are relevant to a location or a context in which they are accessed. Thus, if the first data file 113 is associated with a first location, such as a home, the system 100 may display or otherwise emphasize the first data file 113 if the stored data is accessed from the first location. Similarly, if the second data file 114 is associated with a second location, such as an office, the system 100 may display or otherwise emphasize the second data file 114 if the stored data is accessed from the second location. It can be appreciated that these illustrative examples are provided for illustrative purposes and are not to be construed as limiting.

Also shown in FIG. 1, each computing device 101 and the server computer 110 may also store copies of a note file, where copies of the note file are respectively referenced as 150A, 150B and 150C and collectively and generically referred to herein as a “note file 150.” As can be appreciated, the note file 150 may be a data structure configured to store text, images and/or other data, and the note file 150 may be stored in memory in any format. In one illustrative example, the note file 150 may be configured to work in conjunction with a free-form information gathering and multi-user collaboration application, such as the ONENOTE application from MICROSOFT CORPORATION. In such an example, the note file 150 may have different portions, e.g., different sections, notebooks and pages, each of which may be associated with a location. Thus, each portion may also be emphasized or otherwise highlighted or displayed depending on the location of the computing device 101 accessing the note file 150.

Although the illustrative examples described above involve files and documents having sections, it can be appreciated that data having any data structure stored on any number of computing devices may be used with operations and techniques described herein. In addition, the stored data may include any type of data stored in one or more formats. For instance, the stored data may include spreadsheet files having tabbed sections and/or partitions, word documents having data separated by a page break or section break, etc. As also summarized above, the stored data may include a directory tree containing folders, files and or other data objects.

As will be described in more detail below, subsets of the stored data, such as folders in a directory tree, individual files, sections of files and/or other elements or objects of the stored data, may be associated with one or more locations. When the stored data is accessed from a particular location, the subsets of data associated with the particular location maybe selected and displayed or communicated in a manner that brings emphasis, highlight or focus to the selected subset of data.

The computing devices 101 may also store program modules 111A and 111B (referred to herein collectively and generically as a “program module 111”), each of which may be in the form of a stand-alone application, a productivity application, an operating system component or any other application or software module having features that interact with a user via one or more input devices, such as the input devices 119A and 119B. The input devices may be any device, such as a keyboard, and/or an interface (118A and 118B), which may include a touch-enabled screen configured to receive gestures from one or more users. Each program module 111 may also be configured to manage and process the files and/or other data communicated with other computing devices. In the examples described in more detail below, each program module 111 may be configured to provide location-aware access to data, such as the data files (113 and 114) and note files 150 shown in FIG. 1.

In some configurations, techniques disclosed herein cause the display of selected categories of stored data depending on a geographic location of a computing device. For example, the first data file 113 may be designated by a user or device as a work-related file. At the same time, the second data file 114 may be designated by a user or device as a personal file. Depending on the location of the computing device 101, the program module 111 may only display a file that is associated with, or contextually related to, the location. In the present example, if a computing device 101 accessing the stored data is located at a home of the user, the program module 111 may only display the second data file 114. If a computing device 101 is located at an office of the user, the program module 111 may only display the first data file 113. As can be appreciated, these examples are provided for illustrative purposes and are not to be construed as limiting, as techniques described herein may modify, filter, communicate or display different types of data based on the location of a computing device.

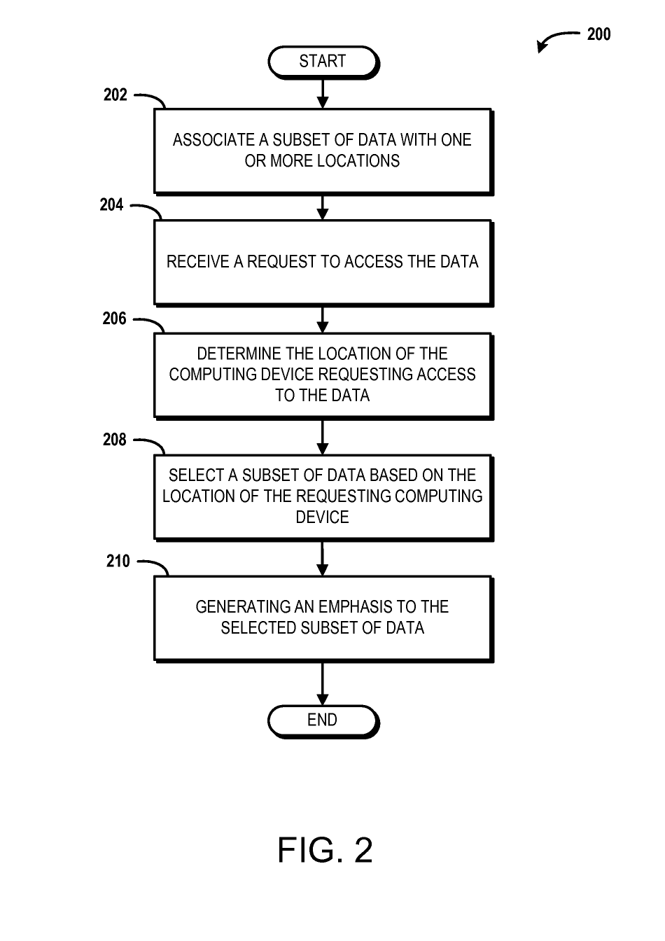

Turning now to FIG. 2, aspects of a routine 200 for providing location-aware data access are shown and described below. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in its entirety. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

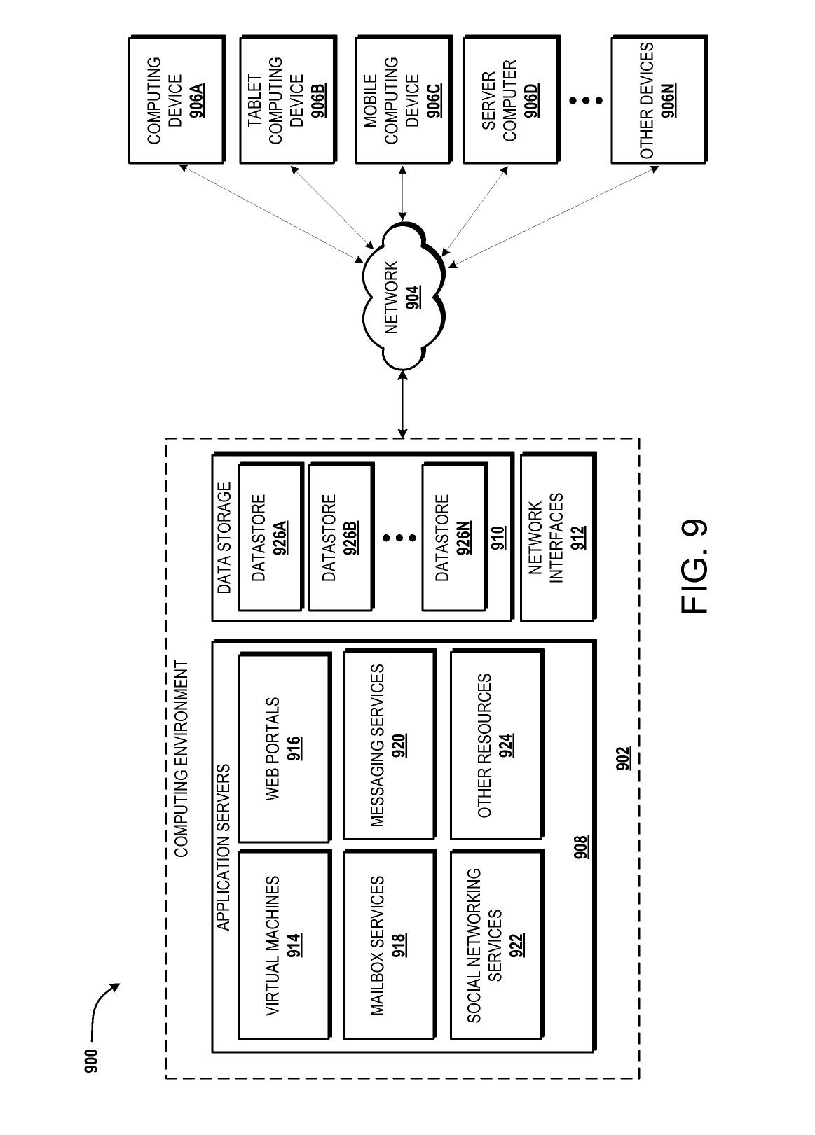

As will be described in more detail below, in conjunction with FIGS. 8-10, the operations of the routine 200 are described herein as being implemented, at least in part, by an application, such as the program module 111. Although the following illustration refers to the program module 111, it can be appreciated that the operations of the routine 200 may be also implemented in many other ways. For example, the routine 200 may be implemented by the use of a note application 813 or any other content creation application or data processing application, e.g., a word processing application, a spreadsheet application, etc. In addition, one or more of the operations of the routine 200 may alternatively or additionally be implemented, at least in part, by a web browser application 810 of FIG. 8 or another application working in conjunction with one or more application servers 908 of FIG. 9.

With reference to FIG. 2, the routine 200 begins at operation 202, where the program module 111 associates at least one location with at least one subset of data. As summarized above, a user may store data in one or more computing devices. The data may include any type of data stored in any format. For instance, the stored data may include a directory tree that includes folders, subfolders, files and/or other data objects. In this example, a subset of the stored data may include a selection of folders, files, objects and/or subfolders. For illustrative purposes, a subset of the stored data may also be referred to herein as a “subset of data” or a “subset.” In some scenarios, a subset of data may include a section or partition of a data structure or file such as a MICROSOFT ONENOTE file, a spreadsheet, a word processing document and/or any other data structure. Operation 202 may include any method for associating location information with any defined subset of the stored data.

In one illustrative example, operation 202 may involve a process of receiving an instruction or command from a user to associate a particular location with a subset of the stored data. The scope of the present disclosure includes any instruction, command or data that may be received from the user that associates any location data with any defined subset of the stored data. In another example, operation 202 may involve a process where a software program or module used for creating, processing or modifying a subset of data may obtain location information and associate the location information with the subset of data being processed. In such configurations, data defining a location may be obtained by a computing device. The location information may be associated with one or more subsets of data that may be created, edited or otherwise processed by one or more software programs or modules.

In another illustrative example, a software module, such as program module 111 may analyze the stored data and generate contextual information that may be used to make the association between a subset of the stored data and any location information. In addition, the contextual information may be generated or modified depending on the functions that are performed on the data. For instance, if a user is creating a document at work, and the document has one or more work-related keywords, the document or portions of the document may be associated with a particular geographic location. In another example, if a document is created at an office location but the list includes a shopping list, the document containing the shopping list may be associated with another location, such as a user's home. However, in another example, if the document is merely viewed in one location, the user's location may not be associated with the subset of data.

These examples are provided for illustrative purposes and are not to be construed as limiting. Further, it can be appreciated that multiple locations may be associated with a particular subset of data. In addition, by the use of one or more GPS devices, network devices and/or other devices providing location information, specific locations, such as a home office or a particular section of a building, may be associated with one or more subsets of data. Further, it can be appreciated that other data may be stored with the location data, such as metadata characterizing a category of data, such as “work-related” or “personal.” Such data may be used by techniques described herein to bring emphasis to the subsets of data when displayed to a user.

Next, at operation 204, one or more computing devices may receive a request to access data. As can be appreciated, operation 204 may involve a request from any computing device accessing stored data. For example, the first computing device 101A may send a request access to access one of the stored files on the server computer 110, such as the first data file 113C. In another example, the request may also be generated by a software module of the first computing device 101A to access data that is locally stored on the computing device 101A, such as the first data file 113A.

In one illustrative example, a request for access to stored data may be generated from a client computing device 101 requesting access to stored files arranged in accordance with a directory tree, such as files stored on the GOOGLE DRIVE file storage service. In another illustrative example, a request for access to stored data may be generated from a client computing device 101 requesting access to notes stored by a service, such as the OFFICE 365 productivity service from MICROSOFT CORPORATION. These examples are provided for illustrative purposes and are not to be construed as limiting, as it can be appreciated that the requested data may include any type of data in any format, stored in a location.

Next, at operation 206, the system 100 may determine the location of the computing device that is requesting access to the data. As can be appreciated, location information may be determined by the use of one or more known technologies. For instance, the location of the computing device requesting accessing to the stored data may be generated by a GPS device. As can be appreciated, the location of the requesting computing device may be identified by one or more sources and/or devices. Thus, in addition to receiving location information from a GPS device, other location data may be received from a network, an accelerometer, gyroscope and/or other devices or systems. As can be appreciated, data from a network may include an IP address or other data that may reveal one or more locations of a computing device. In addition, in some situations, for example, when network data or GPS data may not be available, an accelerometer and/or a gyroscope may be used to track the movement of a device and produce data suitable for determining the location of one or more computing devices.

As summarized above, a geographic location may include any location at any level of specificity. For instance, a geographic location of a computing device may be any defined area, which may be as broad as a city or state. In addition, a geographic location may be a specific location, such as a defined area within a physical structure, e.g., a room of a home. Any data identifying one or more geographic locations may be associated with one or more subsets. Multiple sources of location information, such as a network and a GPS device, may be used to determine if the requesting computing device is located in a specific location.

Next, the routine 200 continues at operation 208 where the system 100 selects one or more subsets of data based on the location of the requesting computing device. In operation 208, the system 100 may analyze the data to be accessed, and the system 100 identifies the associations made between the one or more subsets and the location information that were formed in operation 202. In some configurations, if the system 100 determines that location of the requesting computing device is within a predetermined distance from one of the locations associated with a particular subset, that particular subset may be selected.

As can be appreciated, operation 208 may involve a number of different factors or conditions for selecting a subset. In some configurations, contextual information generated from one or more actions or conditions, such as an action of the user or an action of the requesting computing device, may be used in conjunction with the location information to select one or more subsets. In addition, a user setting or default setting may have one or more conditions or instructions that cause the selection of one or more subsets of data based on location information and/or other contextual information. For example, if a user logs in from home during a particular time of the day, e.g., during business hours, the system 100 may select a first subset of data. Then, in the current example, if the user logs in at other times, e.g., during the evening, a second subset of data may be selected. As can be appreciated, these examples are provided for illustrative purposes and not to be construed as limiting. It can be further appreciated that operation 208 may use many other techniques for selecting a subset of data based on any contextual information, whether the contextual data is used with location information or not. For illustrative purposes, a selected subset of data may also be referred to herein as “selected data.”

In operation 208, the system 100 may also generate data for a selected subset based on the location of the requesting computing device. In some configurations, for example, operation 208 may involve the generation of a new file, section of a file or other data that may be emphasized to the user. In one illustrative example, if a user accesses stored data from a computer at school, the system 100 may populate fields of an existing file or a new file with location information or data related to the location. In such an scenario, the school name or even a course name may be populated in a tab of a note file, page of a word file, or any other data field of any file type. In other examples, new sections, pages or tabs of one or more files may be created and/or populated with contextual data related to the location of the requesting computer. As can be appreciated, these examples are provided for illustrative purposes and are not to be construed as limiting, as operation 208 may select any type of existing or generated data to be utilized in operations described herein.

Next, at operation 210, the program module 111 may generate output data, also referred to herein as an “output,” configured to emphasize the selected data. As summarized above, a number of techniques may be used to emphasize the selected data. For instance, the selected data may be displayed on a user interface or otherwise communicated to a computing device. In such configurations, the display of the selected data may be more prominent than the display of the data that is not selected in operation 208. In addition, the display of the selected data may be separate from the display of the data that is not selected. In some illustrative examples, a user interface may arrange selected data in a prominent location and/or a user interface may bring highlight to the selected data. In such examples, graphical elements, such as colors, highlights or any other visual indicator may be used to highlight the selected data. The display of the selected data may also utilize filters to hide the data that is not selected.

In some configurations, the techniques described herein may associate a priority to the selected data, and the display of the selected data may be based on the priority. For instance, a user interface may arrange selected data in a more prominent location and/or a user interface may bring highlight to the selected data based on an associated priority. In such examples, graphical elements, such as colors, highlights or any other visual indicator may be used to indicate the priority of the selected data.

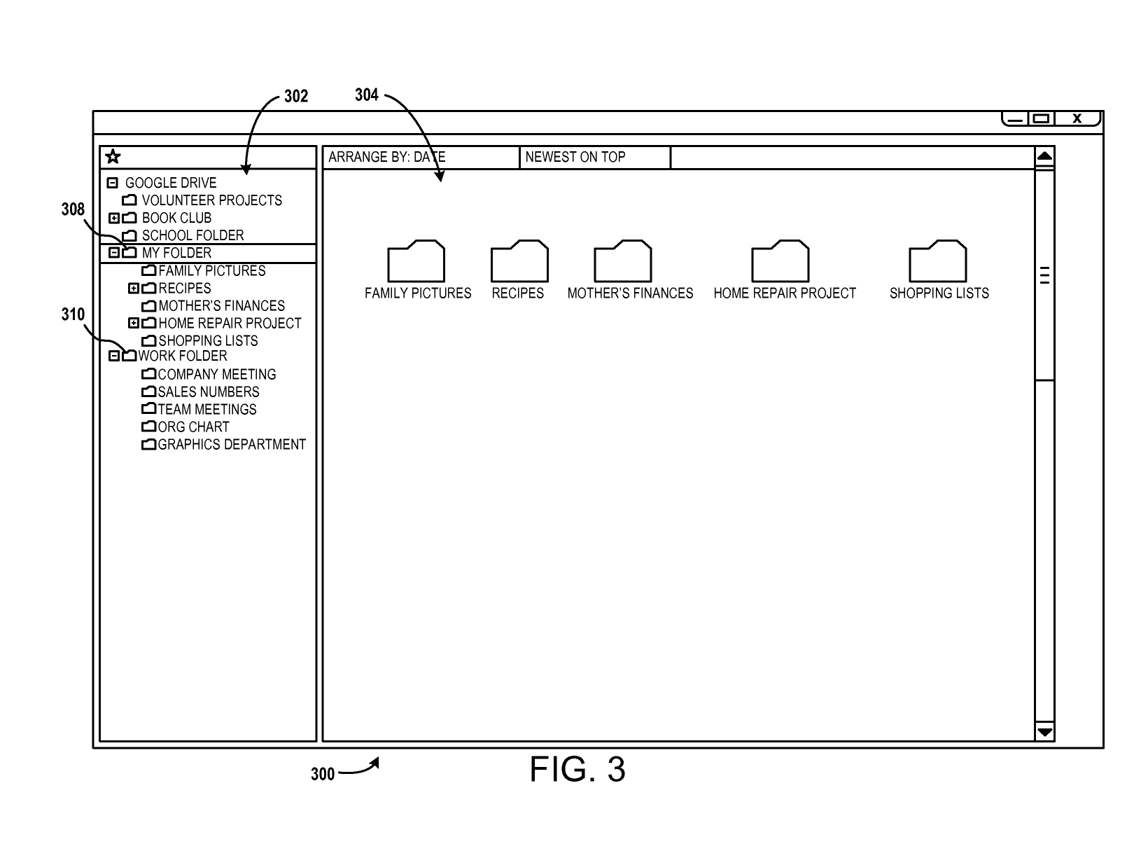

Once the output is generated in operation 210, the routine 200 terminates. As will be explained in the illustrative examples described below, and shown in FIGS. 3-7, an output configured to bring emphasis to the selected data may be in the form of one or more graphical user interfaces that highlight and display representations of the selected data.

FIG. 3 illustrates an example user interface 300 that may be used to emphasize the selected data. In this example, it is a given that the stored data includes a number of files arranged in a directory of folders and subfolders. Also, in this example, for illustrative purposes, it is a given that location data is associated with subsets of the stored data. Specifically, a first subset 308, e.g., a folder labeled “MY FOLDER,” is associated with a first set of locations where a user may interact with personal files, such as a residence, a vacation house or a library. In this example, subfolders and files within MY FOLDER are also associated with the first set of locations.

A second subset 310, e.g., a folder labeled “WORK FOLDER,” is associated with a second set of locations where the user may interact with work-related files, such as an office, a particular room of a residence (a “home office”) or a library. In this example, subfolders and files within WORK FOLDER are also associated with the second set of locations. Also shown in FIG. 3, the example user interface 300 may comprise a directory tree view 302 and a folder display view 304. The directory tree view 302 may comprise a collapsible tree structure showing folders and subfolders. As described in more detail below, the folder display view 304 may display the selected data.

In the present example, the user interface 300 may be generated when the user accesses the stored data from a location, e.g., a residence or vacation house, associated with the first subset 308. As shown, the user interface 300 includes at least one graphical element that emphasizes at least a part of the first subset 308, which in this example, includes a box around the folder labeled “MY FOLDER.” In addition, the folder display view 304 brings further emphasis to the selected data by displaying subfolders of the folder labeled “MY FOLDER.”

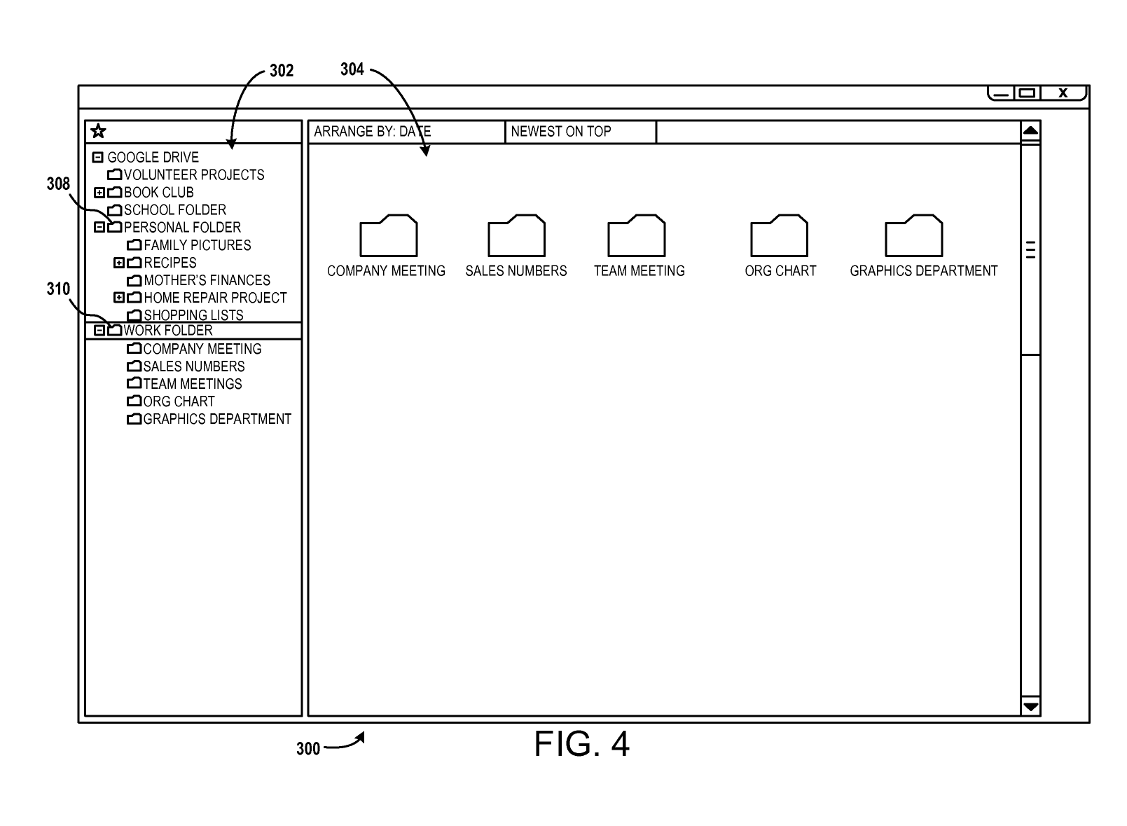

FIG. 4 illustrates another version of the user interface 300 that may be displayed when the user accesses the stored data from another location, e.g., an office, associated with the second subset 310. As shown, the user interface 300 includes at least one graphical element that emphasizes at least a part of the second subset 310, which in this example, includes a box around the folder labeled “WORK FOLDER.” In addition, the folder display view 304 brings further emphasis to the selected data by displaying subfolders of the folder labeled “WORK FOLDER.”

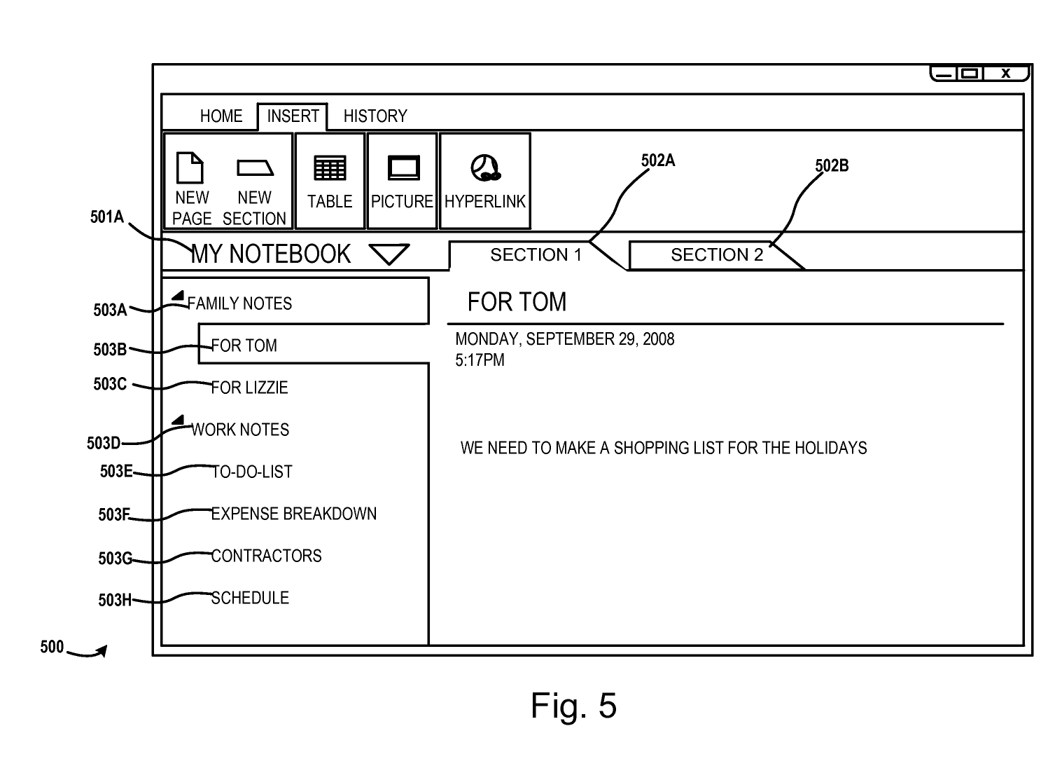

FIGS. 5-7 illustrate other examples of various user interfaces that may be configured to emphasize different types of selected data. As summarized above, the stored data may include any form of data, including a file having portions, sections and/or partitions. As also summarized above, the selected data may include parts of a data structure, such as a parts of a file, sections of a document, etc. In the illustrative examples of FIGS. 5-7, it is a given that the stored data includes a note file 150 shown in FIG. 1, such as one that may be processed by MICROSOFT ONENOTE.

FIG. 5 illustrates an example user interface 500 that may be used to emphasize selected data that is in the form of one or more portions of a document. In this example, the user interface 500 displays aspects of a note file 150 containing individual notebooks, sections and pages. As shown in FIG. 5, the sample notebook is referenced as “MY NOTEBOOK 501A” which contains a number of sections 502A-502B and each section may contain a number of pages 503A-503H.

In the example of FIG. 5, for illustrative purposes, it is a given that location data is associated with subsets of the data. For example, a first example subset including MY NOTEBOOK 501A, the first page 503B of the first section 502A is associated with designated locations where a user may interact with personal files, such as a residence, a vacation house or a library. Using the techniques described above, the user interface 500 of FIG. 5 may be generated when a user accesses the stored data from one of the designated locations, such as the residence or vacation house. As shown in FIG. 5, based on the location of the computer accessing the stored data and the associations between the first example subset and at least one location, the user interface 500 displays the contents of MY NOTEBOOK 501A, the first section 502A and the first page 503B.

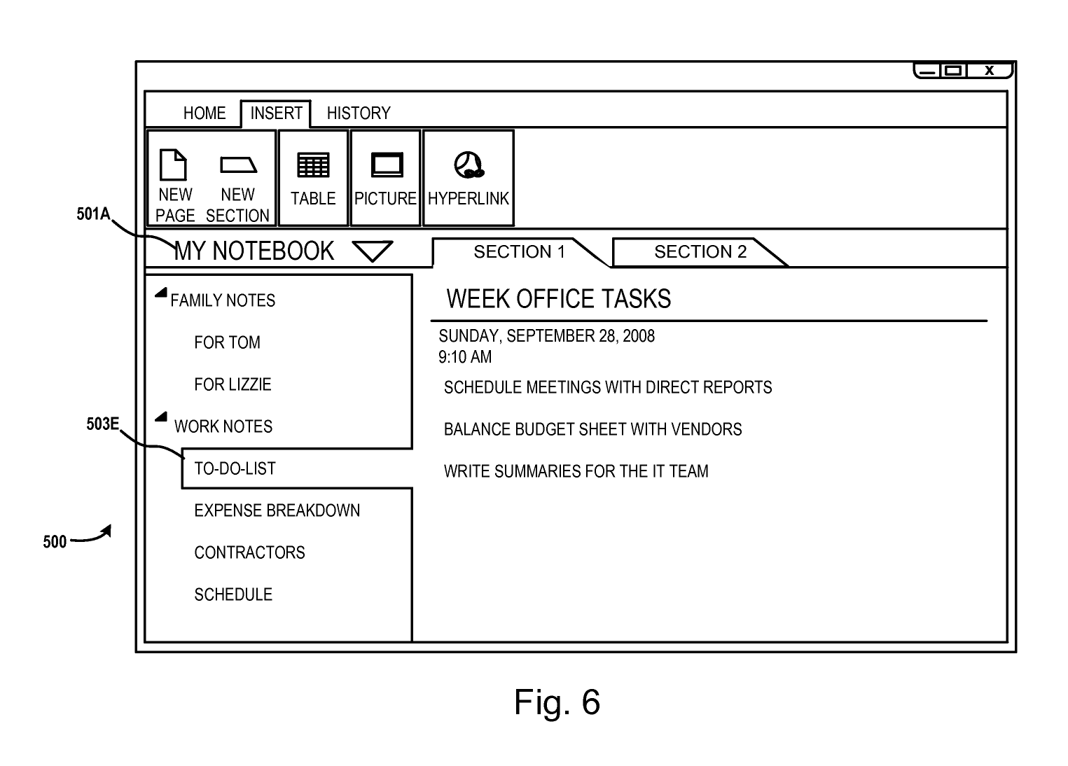

FIG. 6 illustrates another version of the user interface 500 that may be used to emphasize other subsets of data contained in the note file 150. To illustrate other aspects of the present example, it is a given that another set of location data is associated with a second example subset of the stored data. For example, a third page 503E of MY NOTEBOOK 501A is associated with a second set of locations where a user may interact with work-related files, such as an office, a home office, etc. Using the techniques described above, the user interface 500 of FIG. 6 may be generated when a user accesses the stored data from one location of the second set of locations, such as the office. As shown in FIG. 6, based on the location of the computer accessing the stored data and the associations between the second example subset and at least one location, the user interface 500 displays the contents of MY NOTEBOOK 501A and the third page 503E.

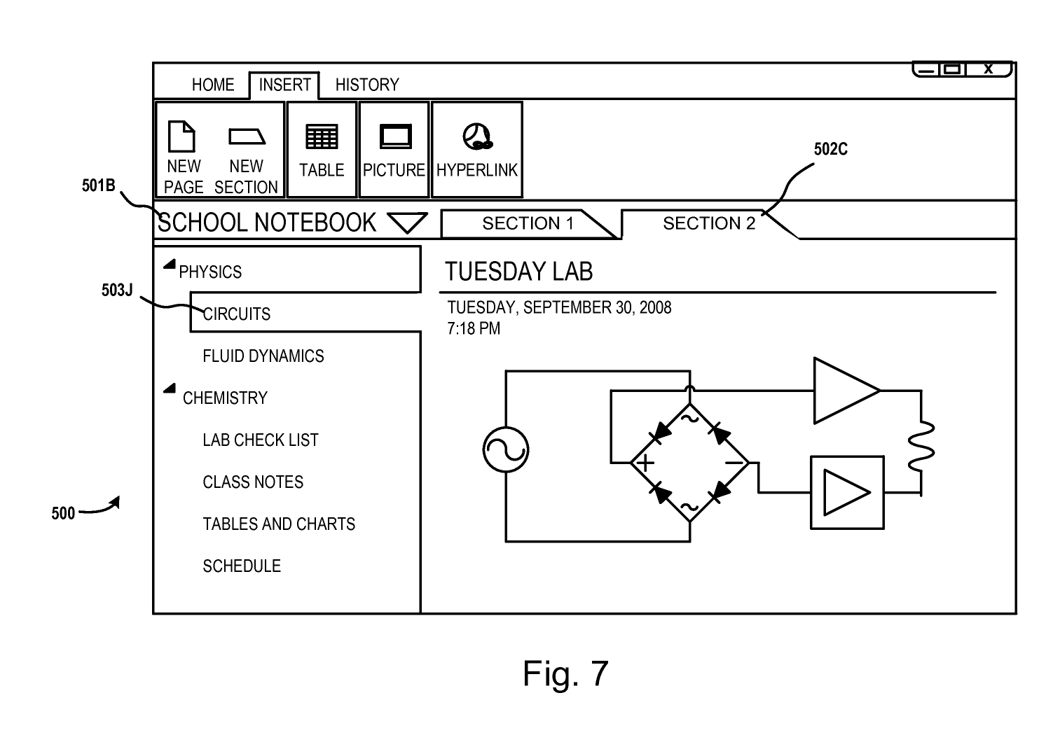

FIG. 7 illustrates yet another version of the user interface 500 that may be used to emphasize other subsets of data contained in the note file 150. More specifically, the example of FIG. 7 is provided to show that techniques disclosed herein may be used to emphasize different notebooks, pages and/or different sections of a note file 150. To illustrate this example, it is a given that another set of location data is associated with subsets of the data. For example, a first page 503J of another notebook, referred to as the SCHOOL NOTEBOOK 501B is associated with a third set of locations where a user may interact with school-related files, such as a classroom, a college campus, etc. Using the techniques described above, the user interface 500 of FIG. 7 may be generated when a user accesses the stored data from one location of the third set of locations, such as a classroom. As shown in FIG. 7, based on the location of the computer accessing the stored data and the associations between a subset of data and at least one location, the user interface 500 displays the contents of the first page 503J of the SCHOOL NOTEBOOK 501B. As can be appreciated, these examples are provided for illustrative purposes and are not to be construed as limiting.

FIG. 8 shows additional details of an example computer architecture 800 for a computer, such as the computing device 101 (FIG. 1), capable of executing the program components described above for providing location-aware data access. Thus, the computer architecture 800 illustrated in FIG. 8 illustrates an architecture for a server computer, mobile phone, a PDA, a smart phone, a desktop computer, a netbook computer, a tablet computer, and/or a laptop computer. The computer architecture 800 may be utilized to execute any aspects of the software components presented herein.

The computer architecture 800 illustrated in FIG. 8 includes a central processing unit 802 (“CPU”), a system memory 804, including a random access memory 806 (“RAM”) and a read-only memory (“ROM”) 808, and a system bus 810 that couples the memory 804 to the CPU 802. A basic input/output system containing the basic routines that help to transfer information between elements within the computer architecture 800, such as during startup, is stored in the ROM 808. The computer architecture 800 further includes a mass storage device 812 for storing an operating system 807, and one or more application programs including, but not limited to, the note application 813, program module 111, and a web browser application 810. The illustrated mass storage device 812 may also store a file 811, which may in any format containing any type of information, note data, word document data, spreadsheet data, etc.

The mass storage device 812 is connected to the CPU 802 through a mass storage controller (not shown) connected to the bus 810. The mass storage device 812 and its associated computer-readable media provide non-volatile storage for the computer architecture 800. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 800.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 800. For purposes the claims, the phrase “computer storage medium,” “computer-readable storage medium” and variations thereof, does not include waves, signals, and/or other transitory and/or intangible communication media, per se.

According to various configurations, the computer architecture 800 may operate in a networked environment using logical connections to remote computers through the network 1056 and/or another network (not shown). The computer architecture 800 may connect to the network 1056 through a network interface unit 814 connected to the bus 810. It should be appreciated that the network interface unit 814 also may be utilized to connect to other types of networks and remote computer systems. The computer architecture 800 also may include an input/output controller 816 for receiving and processing input from a number of other devices, including a keyboard, mouse, or electronic stylus (not shown in FIG. 8). Similarly, the input/output controller 816 may provide output to a display screen, a printer, or other type of output device (also not shown in FIG. 8).

It should be appreciated that the software components described herein may, when loaded into the CPU 802 and executed, transform the CPU 802 and the overall computer architecture 800 from a general-purpose computing system into a special-purpose computing system customized to facilitate the functionality presented herein. The CPU 802 may be constructed from any number of transistors or other discrete circuit elements, which may individually or collectively assume any number of states. More specifically, the CPU 802 may operate as a finite-state machine, in response to executable instructions contained within the software modules disclosed herein. These computer-executable instructions may transform the CPU 802 by specifying how the CPU 802 transitions between states, thereby transforming the transistors or other discrete hardware elements constituting the CPU 802.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 800 in order to store and execute the software components presented herein. It also should be appreciated that the computer architecture 800 may include other types of computing devices, including hand-held computers, embedded computer systems, personal digital assistants, and other types of computing devices known to those skilled in the art. It is also contemplated that the computer architecture 800 may not include all of the components shown in FIG. 8, may include other components that are not explicitly shown in FIG. 8, or may utilize an architecture completely different than that shown in FIG. 8.

FIG. 9 depicts an illustrative distributed computing environment 900 capable of executing the software components described herein for providing location-aware data access, among other aspects. Thus, the distributed computing environment 900 illustrated in FIG. 9 can be utilized to execute any aspects of the software components presented herein. For example, the distributed computing environment 900 can be utilized to execute aspects of the note application 813, the program module 111 and/or other software components described herein.

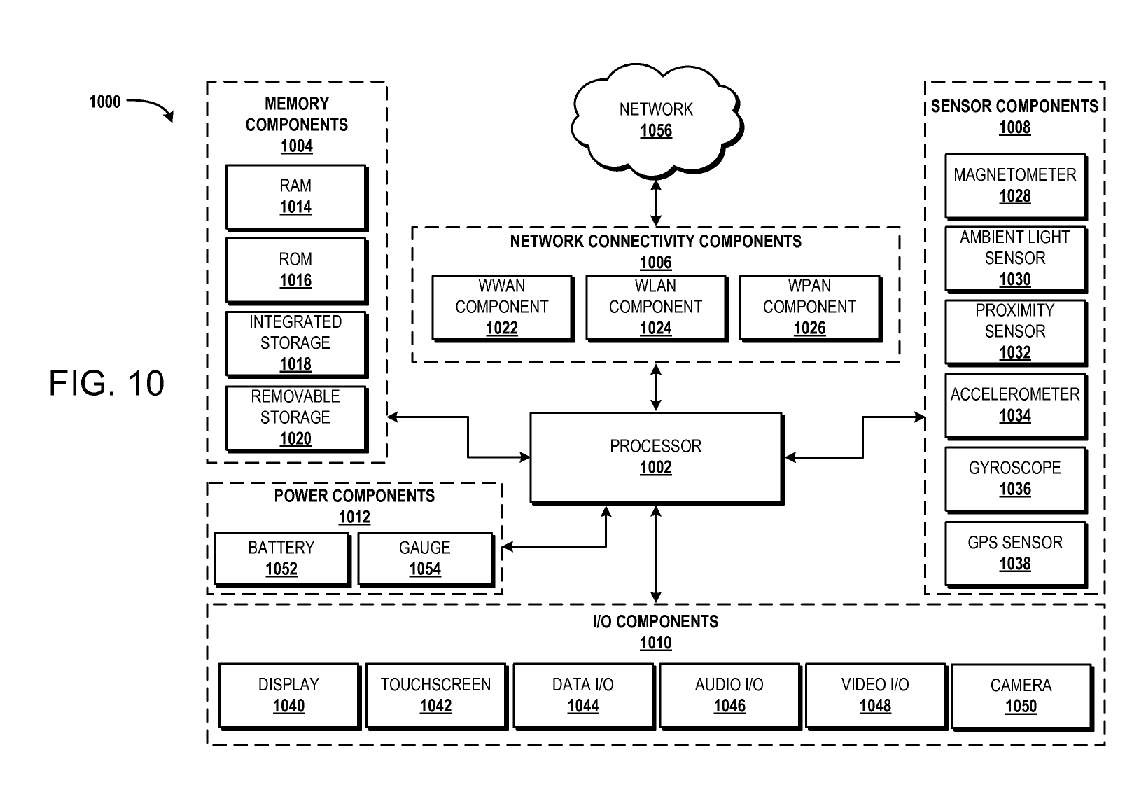

According to various implementations, the distributed computing environment 900 includes a computing environment 902 operating on, in communication with, or as part of the network 904. The network 904 may be or may include the network 1056, described above with reference to FIG. 8. The network 904 also can include various access networks. One or more client devices 906A-906N (hereinafter referred to collectively and/or generically as “clients 906”) can communicate with the computing environment 902 via the network 904 and/or other connections (not illustrated in FIG. 9). In one illustrated configuration, the clients 906 include a computing device 906A such as a laptop computer, a desktop computer, or other computing device; a slate or tablet computing device (“tablet computing device”) 906B; a mobile computing device 906C such as a mobile telephone, a smart phone, or other mobile computing device; a server computer 906D; and/or other devices 906N. It should be understood that any number of clients 906 can communicate with the computing environment 902. Two example computing architectures for the clients 906 are illustrated and described herein with reference to FIGS. 8 and 10. It should be understood that the illustrated clients 906 and computing architectures illustrated and described herein are illustrative, and should not be construed as being limited in any way.

In the illustrated configuration, the computing environment 902 includes application servers 908, data storage 910, and one or more network interfaces 912. According to various implementations, the functionality of the application servers 908 can be provided by one or more server computers that are executing as part of, or in communication with, the network 904. The application servers 908 can host various services, virtual machines, portals, and/or other resources. In the illustrated configuration, the application servers 908 host one or more virtual machines 914 for hosting applications or other functionality. According to various implementations, the virtual machines 914 host one or more applications and/or software modules for providing location-aware data access. It should be understood that this configuration is illustrative, and should not be construed as being limiting in any way. The application servers 908 also host or provide access to one or more portals, link pages, Web sites, and/or other information (“Web portals”) 916.

According to various implementations, the application servers 908 also include one or more mailbox services 918 and one or more messaging services 920. The mailbox services 918 can include electronic mail (“email”) services. The mailbox services 918 also can include various personal information management (“PIM”) services including, but not limited to, calendar services, contact management services, collaboration services, and/or other services. The messaging services 920 can include, but are not limited to, instant messaging services, chat services, forum services, and/or other communication services.

The application servers 908 also may include one or more social networking services 922. The social networking services 922 can include various social networking services including, but not limited to, services for sharing or posting status updates, instant messages, links, photos, videos, and/or other information; services for commenting or displaying interest in articles, products, blogs, or other resources; and/or other services. In some configurations, the social networking services 922 are provided by or include the FACEBOOK social networking service, the LINKEDIN professional networking service, the MYSPACE social networking service, the FOURSQUARE geographic networking service, the YAMMER office colleague networking service, and the like. In other configurations, the social networking services 922 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Washington. Other services are possible and are contemplated.

The social networking services 922 also can include commenting, blogging, and/or micro blogging services. Examples of such services include, but are not limited to, the YELP commenting service, the KUDZU review service, the OFFICETALK enterprise micro blogging service, the TWITTER messaging service, the GOOGLE BUZZ service, and/or other services. It should be appreciated that the above lists of services are not exhaustive and that numerous additional and/or alternative social networking services 922 are not mentioned herein for the sake of brevity. As such, the above configurations are illustrative, and should not be construed as being limited in any way. According to various implementations, the social networking services 922 may host one or more applications and/or software modules for providing the functionality described herein for providing location-aware data access. For instance, any one of the application servers 908 may communicate or facilitate the functionality and features described herein. For instance, a social networking application, mail client, messaging client or a browser running on a phone or any other client 906 may communicate with a networking service 922 and facilitate the functionality, even in part, described above with respect to FIG. 2.

As shown in FIG. 9, the application servers 908 also can host other services, applications, portals, and/or other resources (“other resources”) 924. The other resources 924 can include, but are not limited to, OCR or spreadsheet display functionality. It thus can be appreciated that the computing environment 902 can provide integration of the concepts and technologies disclosed herein provided herein with various mailbox, messaging, social networking, and/or other services or resources.

As mentioned above, the computing environment 902 can include the data storage 910. According to various implementations, the functionality of the data storage 910 is provided by one or more databases operating on, or in communication with, the network 904. The functionality of the data storage 910 also can be provided by one or more server computers configured to host data for the computing environment 902. The data storage 910 can include, host, or provide one or more real or virtual datastores 926A-926N (hereinafter referred to collectively and/or generically as “datastores 926”). The datastores 926 are configured to host data used or created by the application servers 908 and/or other data. Although not illustrated in FIG. 9, the datastores 926 also can host or store note files, word files, spreadsheet files, data structures, algorithms for execution by a recommendation engine, and/or other data utilized by any application program or another module, such as the program module 111. Aspects of the datastores 926 and/or data within the datastores 926 may be associated with data defining one or more geographic locations and/or a geographic area.

The computing environment 902 can communicate with, or be accessed by, the network interfaces 912. The network interfaces 912 can include various types of network hardware and software for supporting communications between two or more computing devices including, but not limited to, the clients 906 and the application servers 908. It should be appreciated that the network interfaces 912 also may be utilized to connect to other types of networks and/or computer systems.

It should be understood that the distributed computing environment 900 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 900 provides the software functionality described herein as a service to the clients 906. It should be understood that the clients 906 can include real or virtual machines including, but not limited to, server computers, web servers, personal computers, mobile computing devices, smart phones, and/or other devices. As such, various configurations of the concepts and technologies disclosed herein enable any device configured to access the distributed computing environment 900 to utilize the functionality described herein for providing location-aware data access, among other aspects. In one specific example, as summarized above, techniques described herein may be implemented, at least in part, by the web browser application 810 of FIG. 8, which works in conjunction with the application servers 908 of FIG. 9.

Turning now to FIG. 10, an illustrative computing device architecture 1000 for a computing device that is capable of executing various software components described herein for providing location-aware data access. The computing device architecture 1000 is applicable to computing devices that facilitate mobile computing due, in part, to form factor, wireless connectivity, and/or battery-powered operation. In some configurations, the computing devices include, but are not limited to, mobile telephones, tablet devices, slate devices, portable video game devices, and the like. The computing device architecture 1000 is applicable to any of the clients 906 shown in FIG. 9. Moreover, aspects of the computing device architecture 1000 may be applicable to traditional desktop computers, portable computers (e.g., laptops, notebooks, ultra-portables, and netbooks), server computers, and other computer systems, such as described herein with reference to FIG. 8. For example, the single touch and multi-touch aspects disclosed herein below may be applied to desktop computers that utilize a touchscreen or some other touch-enabled device, such as a touch-enabled track pad or touch-enabled mouse.

The computing device architecture 1000 illustrated in FIG. 10 includes a processor 1002, memory components 1004, network connectivity components 1006, sensor components 1008, input/output components 1010, and power components 1012. In the illustrated configuration, the processor 1002 is in communication with the memory components 1004, the network connectivity components 1006, the sensor components 1008, the input/output (“I/O”) components 1010, and the power components 1012. Although no connections are shown between the individuals components illustrated in FIG. 10, the components can interact to carry out device functions. In some configurations, the components are arranged so as to communicate via one or more busses (not shown).

The processor 1002 includes a central processing unit (“CPU”) configured to process data, execute computer-executable instructions of one or more application programs, and communicate with other components of the computing device architecture 1000 in order to perform various functionality described herein. The processor 1002 may be utilized to execute aspects of the software components presented herein and, particularly, those that utilize, at least in part, a touch-enabled input.

In some configurations, the processor 1002 includes a graphics processing unit (“GPU”) configured to accelerate operations performed by the CPU, including, but not limited to, operations performed by executing general-purpose scientific and/or engineering computing applications, as well as graphics-intensive computing applications such as high resolution video (e.g., 720P, 1080P, and higher resolution), video games, three-dimensional (“3D”) modeling applications, and the like. In some configurations, the processor 1002 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some configurations, the processor 1002 is, or is included in, a system-on-chip (“SoC”) along with one or more of the other components described herein below. For example, the SoC may include the processor 1002, a GPU, one or more of the network connectivity components 1006, and one or more of the sensor components 1008. In some configurations, the processor 1002 is fabricated, in part, utilizing a package-on-package (“PoP”) integrated circuit packaging technique. The processor 1002 may be a single core or multi-core processor.

The processor 1002 may be created in accordance with an ARM architecture, available for license from ARM HOLDINGS of Cambridge, United Kingdom. Alternatively, the processor 1002 may be created in accordance with an x86 architecture, such as is available from INTEL CORPORATION of Mountain View, California and others. In some configurations, the processor 1002 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 1004 include a random access memory (“RAM”) 1014, a read-only memory (“ROM”) 1016, an integrated storage memory (“integrated storage”) 1018, and a removable storage memory (“removable storage”) 1020. In some configurations, the RAM 1014 or a portion thereof, the ROM 1016 or a portion thereof, and/or some combination the RAM 1014 and the ROM 1016 is integrated in the processor 1002. In some configurations, the ROM 1016 is configured to store a firmware, an operating system or a portion thereof (e.g., operating system kernel), and/or a bootloader to load an operating system kernel from the integrated storage 1018 and/or the removable storage 1020.

The integrated storage 1018 can include a solid-state memory, a hard disk, or a combination of solid-state memory and a hard disk. The integrated storage 1018 may be soldered or otherwise connected to a logic board upon which the processor 1002 and other components described herein also may be connected. As such, the integrated storage 1018 is integrated in the computing device. The integrated storage 1018 is configured to store an operating system or portions thereof, application programs, data, and other software components described herein.

The removable storage 1020 can include a solid-state memory, a hard disk, or a combination of solid-state memory and a hard disk. In some configurations, the removable storage 1020 is provided in lieu of the integrated storage 1018. In other configurations, the removable storage 1020 is provided as additional optional storage. In some configurations, the removable storage 1020 is logically combined with the integrated storage 1018 such that the total available storage is made available as a total combined storage capacity. In some configurations, the total combined capacity of the integrated storage 1018 and the removable storage 1020 is shown to a user instead of separate storage capacities for the integrated storage 1018 and the removable storage 1020.

The removable storage 1020 is configured to be inserted into a removable storage memory slot (not shown) or other mechanism by which the removable storage 1020 is inserted and secured to facilitate a connection over which the removable storage 1020 can communicate with other components of the computing device, such as the processor 1002. The removable storage 1020 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 1004 can store an operating system. According to various configurations, the operating system includes, but is not limited to, SYMBIAN OS from SYMBIAN LIMITED, WINDOWS MOBILE OS from Microsoft Corporation of Redmond, Washington, WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 1006 include a wireless wide area network component (“WWAN component”) 1022, a wireless local area network component (“WLAN component”) 1024, and a wireless personal area network component (“WPAN component”) 1026. The network connectivity components 1006 facilitate communications to and from the network 1056 or another network, which may be a WWAN, a WLAN, or a WPAN. Although only the network 1056 is illustrated, the network connectivity components 1006 may facilitate simultaneous communication with multiple networks, including the network 904 of FIG. 9. For example, the network connectivity components 1006 may facilitate simultaneous communications with multiple networks via one or more of a WWAN, a WLAN, or a WPAN.

The network 1056 may be or may include a WWAN, such as a mobile telecommunications network utilizing one or more mobile telecommunications technologies to provide voice and/or data services to a computing device utilizing the computing device architecture 1000 via the WWAN component 1022. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 1056 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 104 may be configured to provide voice and/or data communications with any combination of the above technologies. The network 1056 may be configured to or adapted to provide voice and/or data communications in accordance with future generation technologies.

In some configurations, the WWAN component 1022 is configured to provide dual- multi-mode connectivity to the network 1056. For example, the WWAN component 1022 may be configured to provide connectivity to the network 1056, wherein the network 1056 provides service via GSM and UMTS technologies, or via some other combination of technologies. Alternatively, multiple WWAN components 1022 may be utilized to perform such functionality, and/or provide additional functionality to support other non-compatible technologies (i.e., incapable of being supported by a single WWAN component). The WWAN component 1022 may facilitate similar connectivity to multiple networks (e.g., a UMTS network and an LTE network).

The network 1056 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 1024 is configured to connect to the network 1056 via the WI-FI access points. Such connections may be secured via various encryption technologies including, but not limited, WI-FI Protected Access (“WPA”), WPA2, Wired Equivalent Privacy (“WEP”), and the like.

The network 1056 may be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 1026 is configured to facilitate communications with other devices, such as peripherals, computers, or other computing devices via the WPAN.

The sensor components 1008 include a magnetometer 1028, an ambient light sensor 1030, a proximity sensor 1032, an accelerometer 1034, a gyroscope 1036, and a Global Positioning System sensor (“GPS sensor”) 1038. It is contemplated that other sensors, such as, but not limited to, temperature sensors or shock detection sensors, also may be incorporated in the computing device architecture 1000.

The magnetometer 1028 is configured to measure the strength and direction of a magnetic field. In some configurations the magnetometer 1028 provides measurements to a compass application program stored within one of the memory components 1004 in order to provide a user with accurate directions in a frame of reference including the cardinal directions, north, south, east, and west. Similar measurements may be provided to a navigation application program that includes a compass component. Other uses of measurements obtained by the magnetometer 1028 are contemplated.

The ambient light sensor 1030 is configured to measure ambient light. In some configurations, the ambient light sensor 1030 provides measurements to an application program stored within one the memory components 1004 in order to automatically adjust the brightness of a display (described below) to compensate for low-light and high-light environments. Other uses of measurements obtained by the ambient light sensor 1030 are contemplated.

The proximity sensor 1032 is configured to detect the presence of an object or thing in proximity to the computing device without direct contact. In some configurations, the proximity sensor 1032 detects the presence of a user's body (e.g., the user's face) and provides this information to an application program stored within one of the memory components 1004 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 1032 are contemplated.

The accelerometer 1034 is configured to measure proper acceleration. In some configurations, output from the accelerometer 1034 is used by an application program as an input mechanism to control some functionality of the application program. For example, the application program may be a video game in which a character, a portion thereof, or an object is moved or otherwise manipulated in response to input received via the accelerometer 1034. In some configurations, output from the accelerometer 1034 is provided to an application program for use in switching between landscape and portrait modes, calculating coordinate acceleration, or detecting a fall. Other uses of the accelerometer 1034 are contemplated.

The gyroscope 1036 is configured to measure and maintain orientation. In some configurations, output from the gyroscope 1036 is used by an application program as an input mechanism to control some functionality of the application program. For example, the gyroscope 1036 can be used for accurate recognition of movement within a 3D environment of a video game application or some other application. In some configurations, an application program utilizes output from the gyroscope 1036 and the accelerometer 1034 to enhance control of some functionality of the application program. Other uses of the gyroscope 1036 are contemplated.

The GPS sensor 1038 is configured to receive signals from GPS satellites for use in calculating a location. The location calculated by the GPS sensor 1038 may be used by any application program that requires or benefits from location information. For example, the location calculated by the GPS sensor 1038 may be used with a navigation application program to provide directions from the location to a destination or directions from the destination to the location. Moreover, the GPS sensor 1038 may be used to provide location information to an external location-based service, such as E911 service. The GPS sensor 1038 may obtain location information generated via WI-FI, WIMAX, and/or cellular triangulation techniques utilizing one or more of the network connectivity components 1006 to aid the GPS sensor 1038 in obtaining a location fix. The GPS sensor 1038 may also be used in Assisted GPS (“A-GPS”) systems.

The I/O components 1010 include a display 1040, a touchscreen 1042, a data I/O interface component (“data I/O”) 1044, an audio I/O interface component (“audio I/O”) 1046, a video I/O interface component (“video I/O”) 1048, and a camera 1050. In some configurations, the display 1040 and the touchscreen 1042 are combined. In some configurations two or more of the data I/O component 1044, the audio I/O component 1046, and the video I/O component 1048 are combined. The I/O components 1010 may include discrete processors configured to support the various interface described below, or may include processing functionality built-in to the processor 1002.

The display 1040 is an output device configured to present information in a visual form. In particular, the display 1040 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 1040 is a liquid crystal display (“LCD”) utilizing any active or passive matrix technology and any backlighting technology (if used). In some configurations, the display 1040 is an organic light emitting diode (“OLED”) display. Other display types are contemplated.

The touchscreen 1042, also referred to herein as a “touch-enabled screen,” is an input device configured to detect the presence and location of a touch. The touchscreen 1042 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some configurations, the touchscreen 1042 is incorporated on top of the display 1040 as a transparent layer to enable a user to use one or more touches to interact with objects or other information presented on the display 1040. In other configurations, the touchscreen 1042 is a touch pad incorporated on a surface of the computing device that does not include the display 1040. For example, the computing device may have a touchscreen incorporated on top of the display 1040 and a touch pad on a surface opposite the display 1040.

In some configurations, the touchscreen 1042 is a single-touch touchscreen. In other configurations, the touchscreen 1042 is a multi-touch touchscreen. In some configurations, the touchscreen 1042 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 1042. As such, a developer may create gestures that are specific to a particular application program.

In some configurations, the touchscreen 1042 supports a tap gesture in which a user taps the touchscreen 1042 once on an item presented on the display 1040. The tap gesture may be used for various reasons including, but not limited to, opening or launching whatever the user taps. In some configurations, the touchscreen 1042 supports a double tap gesture in which a user taps the touchscreen 1042 twice on an item presented on the display 1040. The double tap gesture may be used for various reasons including, but not limited to, zooming in or zooming out in stages. In some configurations, the touchscreen 1042 supports a tap and hold gesture in which a user taps the touchscreen 1042 and maintains contact for at least a pre-defined time. The tap and hold gesture may be used for various reasons including, but not limited to, opening a context-specific menu.

In some configurations, the touchscreen 1042 supports a pan gesture in which a user places a finger on the touchscreen 1042 and maintains contact with the touchscreen 1042 while moving the finger on the touchscreen 1042. The pan gesture may be used for various reasons including, but not limited to, moving through screens, images, or menus at a controlled rate. Multiple finger pan gestures are also contemplated. In some configurations, the touchscreen 1042 supports a flick gesture in which a user swipes a finger in the direction the user wants the screen to move. The flick gesture may be used for various reasons including, but not limited to, scrolling horizontally or vertically through menus or pages. In some configurations, the touchscreen 1042 supports a pinch and stretch gesture in which a user makes a pinching motion with two fingers (e.g., thumb and forefinger) on the touchscreen 1042 or moves the two fingers apart. The pinch and stretch gesture may be used for various reasons including, but not limited to, zooming gradually in or out of a website, map, or picture.

Although the above gestures have been described with reference to the use one or more fingers for performing the gestures, other appendages such as toes or objects such as styluses may be used to interact with the touchscreen 1042. As such, the above gestures should be understood as being illustrative and should not be construed as being limiting in any way.

The data I/O interface component 1044 is configured to facilitate input of data to the computing device and output of data from the computing device. In some configurations, the data I/O interface component 1044 includes a connector configured to provide wired connectivity between the computing device and a computer system, for example, for synchronization operation purposes. The connector may be a proprietary connector or a standardized connector such as USB, micro-USB, mini-USB, or the like. In some configurations, the connector is a dock connector for docking the computing device with another device such as a docking station, audio device (e.g., a digital music player), or video device.

The audio I/O interface component 1046 is configured to provide audio input and/or output capabilities to the computing device. In some configurations, the audio I/O interface component 1046 includes a microphone configured to collect audio signals. In some configurations, the audio I/O interface component 1046 includes a headphone jack configured to provide connectivity for headphones or other external speakers. In some configurations, the audio I/O interface component 1046 includes a speaker for the output of audio signals. In some configurations, the audio I/O interface component 1046 includes an optical audio cable out.

The video I/O interface component 1048 is configured to provide video input and/or output capabilities to the computing device. In some configurations, the video I/O interface component 1048 includes a video connector configured to receive video as input from another device (e.g., a video media player such as a DVD or BLURAY player) or send video as output to another device (e.g., a monitor, a television, or some other external display). In some configurations, the video I/O interface component 1048 includes a High-Definition Multimedia Interface (“HDMI”), mini-HDMI, micro-HDMI, DisplayPort, or proprietary connector to input/output video content. In some configurations, the video I/O interface component 1048 or portions thereof is combined with the audio I/O interface component 1046 or portions thereof.

The camera 1050 can be configured to capture still images and/or video. The camera 1050 may utilize a charge coupled device (“CCD”) or a complementary metal oxide semiconductor (“CMOS”) image sensor to capture images. In some configurations, the camera 1050 includes a flash to aid in taking pictures in low-light environments. Settings for the camera 1050 may be implemented as hardware or software buttons.

Although not illustrated, one or more hardware buttons may also be included in the computing device architecture 1000. The hardware buttons may be used for controlling some operational aspect of the computing device. The hardware buttons may be dedicated buttons or multi-use buttons. The hardware buttons may be mechanical or sensor-based.

The illustrated power components 1012 include one or more batteries 1052, which can be connected to a battery gauge 1054. The batteries 1052 may be rechargeable or disposable. Rechargeable battery types include, but are not limited to, lithium polymer, lithium ion, nickel cadmium, and nickel metal hydride. Each of the batteries 1052 may be made of one or more cells.

The battery gauge 1054 can be configured to measure battery parameters such as current, voltage, and temperature. In some configurations, the battery gauge 1054 is configured to measure the effect of a battery's discharge rate, temperature, age and other factors to predict remaining life within a certain percentage of error. In some configurations, the battery gauge 1054 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 1012 may also include a power connector, which may be combined with one or more of the aforementioned I/O components 1010. The power components 1012 may interface with an external power system or charging equipment via an I/O component.

The disclosure presented herein may be considered in view of the following clauses.

Clause 1: A computer-implemented example including operations for: obtaining, at a computing device (101), a request to access stored data; obtaining data defining a location of the computing device (101); selecting a subset of the stored data based on the location of the computing device (101), wherein the subset of the stored data includes at least one data file (113) and at least one folder (308) associated with the data file (113); and generating an output (300) configured to emphasize the subset of the stored data.

Clause 2: The example of clause 1, further including associating a geographic location with the subset of the stored data; determining if the location of the computing device is within a predetermined distance from the geographic location; and selecting the subset of the stored data if the location of the computing device is within a predetermined distance from the geographic location.

Clause 3: The example of clauses 1-2, further including interpreting the stored data to generate contextual data identifying at least one geographic location; associating the at least one geographic location with the subset of the stored data based on the contextual data, wherein selecting the subset of the stored data based on the location of the computing device comprises determining if the location of the computing device is within a predetermined distance from the at least one geographic location; and selecting the subset of the stored data if it is determined that the location of the computing device is within a predetermined distance from the at least one geographic location.

Clause 4: The example of clauses 1-3, wherein the stored data comprises a plurality of files configured in an arrangement defined by a directory tree of folders, and wherein the method further comprises: associating at least one geographic location with at least one folder and at least one file of the plurality of files; determining if the location of the computing device is within a predetermined distance from the geographic location; selecting the subset of the stored data if the location of the computing device is within a predetermined distance from the geographic location, the subset including the at least one folder and the at least one file; and generating a user interface based on the output, the user interface configured to display the at least one folder and the at least one file.

Clause 5: The example of clauses 1-4, wherein the user interface is configured to display the at least one folder and the at least one file separately from at least one other file of the plurality of files.

Clause 6: The example of clauses 1-5, wherein the stored data comprises a plurality of files, and wherein the method further includes associating at least one geographic location with at least one file of the plurality of files; determining if the location of the computing device is within a predetermined distance from the geographic location; selecting the subset of the stored data if the location of the computing device is within a predetermined distance from the geographic location, the subset including the at least one file; and generating a user interface based on the output, the user interface configured to display the at least one file.

Clause 7: The example of clauses 1-6, wherein the user interface is configured to display the at least one file separately from at least one other file of the plurality of files.

Clause 8: The example of clauses 1-7, wherein the method further comprises determining a priority for individual subsets of the stored data based, at least in part, on the location of the computing device, and wherein the output is configured based, at least in part, on the priority for the at least one subset of the stored data.

Clause 9: A example computer (1000), comprising: a processor (1002); and a computer-readable storage medium (1004) in communication with the processor (1002), the computer-readable storage medium (1004) having computer-executable instructions stored thereupon which, when executed by the processor (1002), cause the computer (1000) to obtain a request to access a stored file (150) including a plurality of portions, obtain data defining a location of the computer (1000), select at least one portion of the plurality of portions included in the stored file (150), and generate an output (500) configured to emphasize the at least one portion.

Clause 10: The example computer of clause 9, wherein the computer-readable storage medium has further computer-executable instructions stored thereupon, which when executed by the processor, cause the computer to determine a priority for at least one portion of the stored file based, at least in part, on the location of the computer, and wherein the output is configured based, at least in part, on the priority for the at least one portion.

Clause 11: The example computer of clauses 9-10, wherein plurality of portions comprise at least one notebook, at least one page or at least one section, and wherein the computer-readable storage medium has further computer-executable instructions stored thereupon, which when executed by the processor, cause the computer to associate at least one geographic location with the at least one portion of the plurality of portions; determine if the location of the computer is within a predetermined distance from the geographic location; select the at least one portion of the plurality of portions if the location of the computer is within a predetermined distance from the geographic location, wherein the at least one portion comprises the at least one notebook, the at least one page or the at least one section; and generate a user interface based on the output, the user interface configured to display the at least one portion comprising the at least one notebook, the at least one page or the at least one section.

Clause 12: The example computer of clauses 9-11, wherein the computer-readable storage medium has further computer-executable instructions stored thereupon, which when executed by the processor, cause the computer to associate at least one geographic area within a physical structure with the at least one portion of the plurality of portions; determine if the location of the computer is within geographic area; select the at least one portion of the plurality of portions if the location of the computer is within the geographic area; and generate a user interface based on the output, the user interface configured to display the at least one portion of the plurality of portions.

Clause 13: The example computer of clauses 9-12, wherein the computer-readable storage medium has further computer-executable instructions stored thereupon, which when executed by the processor, cause the computer to: interpret the stored file to generate contextual data identifying at least one geographic location; determine if the location of the computer is within a predetermined distance from the geographic location; select the at least one portion of the plurality of portions if the location of the computer is within a predetermined distance from the at least one geographic location.

Clause 14: The example computer of clauses 9-13, wherein the computer-readable storage medium has further computer-executable instructions stored thereupon, which when executed by the processor, cause the computer to generate a user interface based on the output, the user interface configured to display the at least one portion.

Clause 15: A sample computer-readable storage medium (1004) having computer-executable instructions stored thereupon which, when executed by a computer (1000), cause the computer (1000) to: obtain a request to access a stored file (150) including a plurality of portions; obtain data defining a location of the computer (1000); select at least one portion of the plurality of portions included in the stored file (150); and generate an output (500) configured to emphasize the at least one portion.

Clause 16: The example of clause 15, wherein the computer-readable storage medium comprises further computer-executable instructions stored thereupon for causing the computer to determine a priority for at least one portion of the stored file based, at least in part, on the location of the computer, and wherein the output is configured based, at least in part, on the priority for the at least one portion.

Clause 17: The example of clauses 15-16, wherein plurality of portions comprise at least one notebook, at least one page or at least one section, wherein the computer-readable storage medium comprises further computer-executable instructions stored thereupon for causing the computer to: associate at least one geographic location with the at least one portion of the plurality of portions; determine if the location of the computer is within a predetermined distance from the geographic location; select the at least one portion of the plurality of portions if the location of the computer is within a predetermined distance from the geographic location, wherein the at least one portion comprises the at least one notebook, the at least one page or the at least one section; and generate a user interface based on the output, the user interface configured to display the at least one portion comprising the at least one notebook, the at least one page or the at least one section.

Clause 18: The example of clauses 15-17, wherein the computer-readable storage medium comprises further computer-executable instructions stored thereupon for causing the computer to: associate at least one geographic location with the at least one portion of the plurality of portions; determine if the location of the computer is within a predetermined distance from the geographic location; select the at least one portion of the plurality of portions if the location of the computer is within a predetermined distance from the geographic location; and generate a user interface based on the output, the user interface configured to display the at least one portion of the plurality of portions.

Clause 19: The example of clauses 15-18, wherein the computer-readable storage medium comprises further computer-executable instructions stored thereupon for causing the computer to: interpret the stored file to generate contextual data identifying at least one geographic location; determine if the location of the computer is within a predetermined distance from the geographic location; and select the at least one portion of the plurality of portions if the location of the computer is within a predetermined distance from the at least one geographic location.

Clause 20: The example of clauses 15-19, wherein the computer-readable storage medium comprises further computer-executable instructions stored thereupon for causing the computer to generate a user interface based on the output, the user interface configured to display the at least one portion.

Based on the foregoing, it should be appreciated that concepts and technologies have been disclosed herein that provide location-aware data access. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example configurations and applications illustrated and described, and without departing from the true spirit and scope of the present invention, which is set forth in the following claims.

What is claimed is:

1. A computer-implemented method comprising:
obtaining, at a computing device, a request to access stored data;
obtaining data defining a location of the computing device;
selecting a subset of the stored data based on the location of the computing device, wherein the subset of the stored data includes at least one data file and at least one folder associated with the data file; and
generating an output configured to emphasize the subset of the stored data.

2. The computer-implemented method of claim 1, further comprising:
associating a geographic location with the subset of the stored data;
determining if the location of the computing device is within a predetermined distance from the geographic location; and
selecting the subset of the stored data if the location of the computing device is within a predetermined distance from the geographic location.

3. The computer-implemented method of claim 1, further comprising:
interpreting the stored data to generate contextual data identifying at least one geographic location;
associating the at least one geographic location with the subset of the stored data based on the contextual data, wherein selecting the subset of the stored data based on the location of the computing device comprises determining if the location of the computing device is within a predetermined distance from the at least one geographic location; and
selecting the subset of the stored data if it is determined that the location of the computing device is within a predetermined distance from the at least one geographic location.

4. The computer-implemented method of claim 1, wherein the stored data comprises a plurality of files configured in an arrangement defined by a directory tree of folders, and wherein the method further comprises:
associating at least one geographic location with at least one folder and at least one file of the plurality of files;
determining if the location of the computing device is within a predetermined distance from the geographic location;
selecting the subset of the stored data if the location of the computing device is within a predetermined distance from the geographic location, the subset including the at least one folder and the at least one file; and
generating a user interface based on the output, the user interface configured to display the at least one folder and the at least one file.

5. The computer-implemented method of claim 4, wherein the user interface is configured to display the at least one folder and the at least one file separately from at least one other file of the plurality of files.

6. The computer-implemented method of claim 1, wherein the stored data comprises a plurality of files, and wherein the method further comprises:
associating at least one geographic location with at least one file of the plurality of files;
determining if the location of the computing device is within a predetermined distance from the geographic location;
selecting the subset of the stored data if the location of the computing device is within a predetermined distance from the geographic location, the subset including the at least one file; and
generating a user interface based on the output, the user interface configured to display the at least one file.

7. The computer-implemented method of claim 6, wherein the user interface is configured to display the at least one file separately from at least one other file of the plurality of files.

8. The computer-implemented method of claim 1, wherein the method further comprises determining a priority for individual subsets of the stored data based, at least in part, on the location of the computing device, and wherein the output is configured based, at least in part, on the priority for the at least one subset of the stored data.

9. A computer, comprising:
a processor; and
a computer-readable storage medium in communication with the processor, the computer-readable storage medium having computer-executable instructions stored thereupon which, when executed by the processor, cause the computer to
obtain a request to access a stored file including a plurality of portions,
obtain data defining a location of the computer,
select at least one portion of the plurality of portions included in the stored file, and
generate an output configured to emphasize the at least one portion.

10. The computer of claim 9, wherein the computer-readable storage medium has further computer-executable instructions stored thereupon, which when executed by the processor, cause the computer to determine a priority for at least one portion of the stored file based, at least in part, on the location of the computer, and wherein the output is configured based, at least in part, on the priority for the at least one portion.

11. The computer of claim 9, wherein plurality of portions comprise at least one notebook, at least one page or at least one section, and wherein the computer-readable storage medium has further computer-executable instructions stored thereupon, which when executed by the processor, cause the computer to:
associate at least one geographic location with the at least one portion of the plurality of portions;
determine if the location of the computer is within a predetermined distance from the geographic location;
select the at least one portion of the plurality of portions if the location of the computer is within a predetermined distance from the geographic location, wherein the at least one portion comprises the at least one notebook, the at least one page or the at least one section; and
generate a user interface based on the output, the user interface configured to display the at least one portion comprising the at least one notebook, the at least one page or the at least one section.

12. The computer of claim 9, wherein the computer-readable storage medium has further computer-executable instructions stored thereupon, which when executed by the processor, cause the computer to:
associate at least one geographic area within a physical structure with the at least one portion of the plurality of portions;
determine if the location of the computer is within geographic area;
select the at least one portion of the plurality of portions if the location of the computer is within the geographic area; and
generate a user interface based on the output, the user interface configured to display the at least one portion of the plurality of portions.

13. The computer of claim 9, wherein the computer-readable storage medium has further computer-executable instructions stored thereupon, which when executed by the processor, cause the computer to:
interpret the stored file to generate contextual data identifying at least one geographic location;
determine if the location of the computer is within a predetermined distance from the geographic location;
select the at least one portion of the plurality of portions if the location of the computer is within a predetermined distance from the at least one geographic location.

14. The computer of claim 13, wherein the computer-readable storage medium has further computer-executable instructions stored thereupon, which when executed by the processor, cause the computer to generate a user interface based on the output, the user interface configured to display the at least one portion.

15. A computer-readable storage medium having computer-executable instructions stored thereupon which, when executed by a computer, cause the computer to:
obtain a request to access a stored file including a plurality of portions;
obtain data defining a location of the computer;
generate or select at least one portion of the plurality of portions included in the stored file; and
generate an output configured to emphasize the at least one portion.

16. The computer-readable storage medium of claim 15, wherein the computer-readable storage medium comprises further computer-executable instructions stored thereupon for causing the computer to determine a priority for at least one portion of the stored file based, at least in part, on the location of the computer, and wherein the output is configured based, at least in part, on the priority for the at least one portion.

17. The computer-readable storage medium of claim 15, wherein plurality of portions comprise at least one notebook, at least one page or at least one section, wherein the computer-readable storage medium comprises further computer-executable instructions stored thereupon for causing the computer to:
associate at least one geographic location with the at least one portion of the plurality of portions;
determine if the location of the computer is within a predetermined distance from the geographic location;
select the at least one portion of the plurality of portions if the location of the computer is within a predetermined distance from the geographic location, wherein the at least one portion comprises the at least one notebook, the at least one page or the at least one section; and
generate a user interface based on the output, the user interface configured to display the at least one portion comprising the at least one notebook, the at least one page or the at least one section.

18. The computer-readable storage medium of claim 15, wherein the computer-readable storage medium comprises further computer-executable instructions stored thereupon for causing the computer to:
associate at least one geographic location with the at least one portion of the plurality of portions;
determine if the location of the computer is within a predetermined distance from the geographic location;
select the at least one portion of the plurality of portions if the location of the computer is within a predetermined distance from the geographic location; and
generate a user interface based on the output, the user interface configured to display the at least one portion of the plurality of portions.

19. The computer-readable storage medium of claim 15, wherein the computer-readable storage medium comprises further computer-executable instructions stored thereupon for causing the computer to:
interpret the stored file to generate contextual data identifying at least one geographic location;
determine if the location of the computer is within a predetermined distance from the geographic location; and
select the at least one portion of the plurality of portions if the location of the computer is within a predetermined distance from the at least one geographic location.

20. The computer-readable storage medium of claim 19, wherein the computer-readable storage medium comprises further computer-executable instructions stored thereupon for causing the computer to generate a user interface based on the output, the user interface configured to display the at least one portion.
